(19) United States
(12) Patent Application Publication
(10) Pub. No.: US 2016/0048628 A1
(43) Pub. Date: Feb. 18, 2016

(54) METHOD FOR DYNAMIC EXPERIMENTAL DESIGN

(71) Applicant: National Tsing Hua University, Hsinchu City (TW)

(72) Inventors: Chen-Fu Chien, Hsinchu City (TW); Shih-Chung Chuang, Hsinchu City (TW)

(21) Appl. No.: 14/547,731

(22) Filed: Nov. 19, 2014

(30) Foreign Application Priority Data
Aug. 13, 2014 (TW) 103127722

(51) Int. Cl. G06F 17/50

(52) U.S. Cl. CPC G06F 17/5081

(57) ABSTRACT

The present invention discloses a method for dynamic experimental design that is applied in a semiconductor manufacturing process. During an experimental design process, it will be checked whether an experimental target range is changed so as to rebuild an experimental design table and retain completed experimental factors in order achieve the purpose of dynamically adjusting the experimental factors. The method for dynamic experimental design according to the present invention can be effectively applied in the high-tech industry.

### BACKGROUND OF THE INVENTION

1. Field of the Invention

The present invention relates to methods for experimental designs, and, more particularly, to a method for dynamic experimental design that is applied to a semiconductor manufacturing process.

2. Description of Related Art

In automatic production process of high technology industry, especially in a semiconductor manufacturing process, the process parameters of the production platform is a major influential factor that could affect the overall performance of the manufacturing process. This is called factors, and the possible set value of every factor is called a factor level. In order to improve production quality, several experimental designs with different parameters will be carried out before large-scale production, to optimize the performance of the production line of each product through finding the best combination of each factor level. In other words, the main objective of experimental design is to discover the relation between the factors and the quality of a product, so as to find the optimal combination of the process parameters of the production platform.

Experimental designs, such as Taguchi method, Factor design, and D-optimal design, are commonly adopted in the conventional industry. For instance, Taguchi method incorporating the statistic concepts of orthogonal array, applied tactics, and analysis method in view of producing low cost, and high quality products within a shortened amount of development time. This enables limited number of experiment trials without complicated calculation to be performed to systematically search the most preferable combination of parameters. Therefore, Taguchi method is regarded as one of the most widely used method and proven to be very efficient in finding the preferable combinations of parameters in the manufacturing process method of various industrial fields.

Even Taguchi method is regarded as a very speedy and economic experimental design method. However, there are still many challenges that the Taguchi method is facing in the advanced high technology manufacturing process. For instance, in the semiconductor industry, it shall be considered not only that the technology is advancing, but also there are various parameters in the manufacturing platform, and factors may be changed due to any change being made in the production line and flow

In this situation of using Taguchi method, whole experiment is abandoned when the experimental factors are changed to start a new experimental design. In other words, the conventional Taguchi method does not allow any changes in the experimental process, and it does not have the flexibility to modify the factors in real time, thereby unable to be more effectively and flexibly used in the high technology industry.

Accordingly, there is an urgent need to develop a method for experimental design, which can be incorporated in the high technology industry and is able to flexibly change the experimental factors in an experiment.

### SUMMARY OF THE INVENTION

The main objective of the present invention is to provide a method for dynamic experimental design, comprising: defining an experimental target range, and obtaining at least one first factor, a plurality of first factor levels, and a plurality of experimental runs; building a first experimental design table according to the at least one first factor and the experimental runs; inputting the first factor levels to the first experimental design table; executing an experiment according to the first experimental design table; and checking whether the experimental target range is changed during the experiment; wherein if the experimental target range is changed during the experiment, at least one second factor and at least one second factor level are obtained, the at least one second factor is added into a second experimental design table, some of the first factor levels that have completed the experiment and the second factor levels are inputted into the second experimental design table, an experimental design continues, and the experimental target range is kept checked, or an experimental result and an analysis report are outputted.

Another objective of the present invention is to provide a method for dynamic experimental design, comprising: defining an experimental target range, and obtaining at least one first factor, a plurality of first factor levels, and a plurality of experimental runs, wherein the experimental target range comprises a repeat number of experimental designs; building at least one first experimental design table according to the repeat number of experimental designs, the at least one first factor, and the experimental runs; inputting the first factor levels into the first experimental design table; obtaining flexibility of the at least one first factor, and optimizing the first experimental design table, to obtain an experimental design result; checking whether a number of the experimental design result reaches the repeat number of the experimental designs, and if the number of the experimental design result reaches the repeat number of the experimental designs, a most preferable one in the first experimental design table is outputted and the experiment continues, or the step of building the first experimental design table is executed again so as to obtain the experimental design result; and checking whether the experimental target range is changed during the experiment; wherein if the experimental target range is changed during the experiment, at least one second factor and at least one second factor level are obtained, the second factor is added into a second experimental design table, and some of the first factor levels that have completed the experiment and the second factor levels are input into the second experimental design table, the experimental design continues, and the experimental target range is kept checked, or an experimental result and an analysis report are outputted.

### BRIEF DESCRIPTION OF DRAWINGS

The present invention can be more fully understood by reading the following detailed description of the preferred embodiments, with reference made to the accompanying drawings, wherein:

FIG. 1 is a flow chart of a method for dynamic experimental design in accordance with a first embodiment of the present invention; and

FIG. 2 is a flow chart of a method for dynamic experimental design in accordance with another embodiment of the present invention.

### DETAILED DESCRIPTION OF PREFERRED EMBODIMENTS

The present invention is described in the following with specific embodiments, so that one skilled in the pertinent art can easily understand other advantages and effects of the present invention from the disclosure of the present invention.

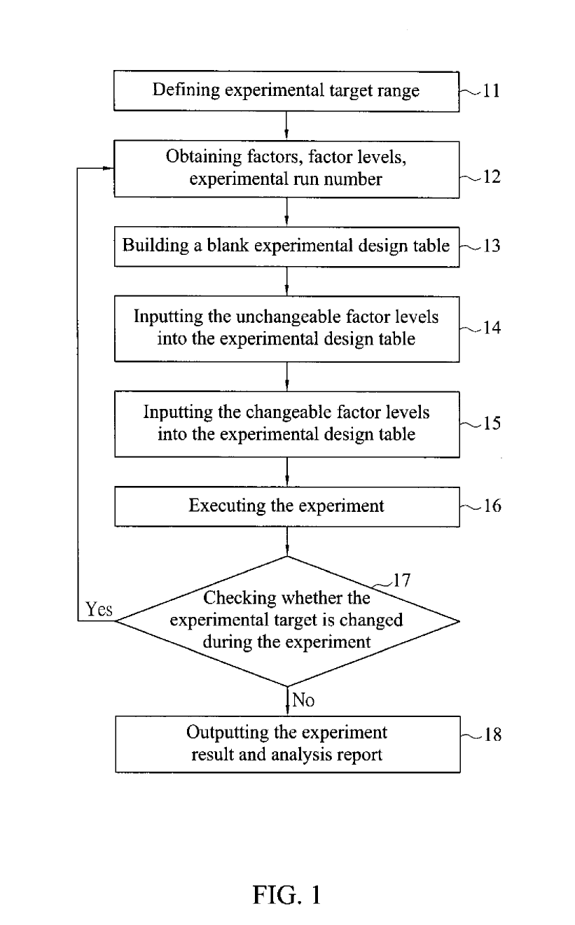

FIG. 1 is a flow chart of a method for dynamic experimental design in accordance with a first embodiment of the present invention. An experimental target range is defined in step 11. Defining experimental target range refers to define a measurement target of an experiment design and any other experiment associated restrictions. The target is used to measure the experiment result. The method proceeds to step 12.

Step 12 involves obtaining the factors, factor levels and experimental runs. In an embodiment, the factor refers to a factor which may affect the manufacturing process which in turn determines the quality of the finished product; and factor level refers to the manufacturing parameter in the processing machine used in semiconductor manufacturing process. For example, temperature, pressure, moist, feed rate, and rotation speed are process associated factors related to semiconductor process, and 50 degrees and 10 degrees are the corresponding factor levels of such factor. Hence, every factor has a plurality of factor levels associated therewith. However, the above examples are only for illustration purpose, the present invention is not limited thereto. In addition, an experimental run refers to the sample number of the experiment. In one experiment, the factor refers to at least one factor, and the factor level, experimental run usually are, but not limited to, in plural. It should be noted that the plurality of factors can be designated as to individual numbers, for instance factor number 3, represents there are 3 factors. The method proceeds to step 13.

Step 13 involves building a blank experimental design table according to the factor number experimental runs, and the experimental design table is substantially an NA-MATRIX. Using factor number (p) and experimental runs (n) as an example, the blank experimental design table is an n×p NA-MATRIX. Using the combination of factor 4, experimental runs 8 as an example, the experimental design table is shown as table 1, wherein F1-F4 represent different factors, and 1-8 of the first line represent experimental run. This is then followed by step 14.

TABLE 1

| | | | |
|---|---|---|---|
| F1 | F2 | F3 | F4 |

1
2
3
4
5
6
7
8

In step 14, the items of the factor levels that are unable to change are inputted in the experimental design table. The factor levels comprise unchangeable factor levels due to experimental restrictions, unchangeable factor levels and changeable factor levels. In an embodiment, the changeable factor levels can be changed without being restricted by the experimental restrictions, but the present invention is not limited thereto. In step 14, the unchangeable factor levels due to experimental restrictions are be inputted in a fixed position of the experimental design table according to the experiment restriction. As shown in table 2, the factor levels X are unchangeable factor levels that are unchangeable. It should be noted, the letter X is only to illustrate the unchangeable factor levels, and does not mean the factor levels have the same meaning or have the same process parameters. The method proceeds to step 15.

TABLE 2

| | F1 | F2 | F3 | F4 |
|---|---|---|---|---|
| 1 | | | X | |
| 2 | | | X | |
| 3 | X | X | X | |
| 4 | X | X | X | |
| 5 | | | X | |
| 6 | | | X | |
| 7 | | | | |
| 8 | | | | |

In step 15, the changeable items of the factor levels are inputted in the experimental design table. More specifically, after the fixed items of the factor levels due to experimental restrictions are inputted in the fixed position of the experimental design table, the changeable factor levels are inputted in the remaining positions of the experimental design table i.e., the positions other than the unchangeable factor levels due to experimental restrictions in the most preferable way. As shown in Table 3, the factor levels Y indicate the changeable factor levels. It should be noted that the letter Y is only to illustrate the unchangeable factor levels, and does not mean that the factor levels are identical or have the same process parameters. The most preferable way refers to the user can freely adopt any calculation method, such as column adjusting method, to input the changeable factor levels. Alternatively, inputting in a random selection way is also applicable, and the present invention is not limited thereto.

TABLE 3

| | F1 | F2 | F3 | F4 |
|---|---|---|---|---|
| 1 | Y | Y | X | Y |
| 2 | Y | Y | X | Y |
| 3 | X | X | X | Y |
| 4 | X | X | X | Y |
| 5 | Y | Y | X | Y |
| 6 | Y | Y | X | Y |
| 7 | Y | Y | Y | Y |
| 8 | Y | Y | Y | Y |

After completely filling in the experimental design table by the factor levels, experiments can be conducted (step 16). During the experiments, whether the experimental target range is changed during the experiments is kept checked (step 17). For instance, adding on the production line, reducing semiconductor manufacturing machines, or modifying manufacturing parameters or production flow cause changes of factors and factor levels. Take adding a machine on the production line during the experiment as an example. The original factors F1-F4 will be changed to F1-F5, and factor levels will also be changed. Since the experimental target range has been changed, the experiment will be in halt, in order to renew the factors and factor levels, and rebuild a new blank experimental design table containing F1-F5 factors. Since the simulation of experiment design is in halt, a portion of the factor levels that has completed the experiments (completed calculation), are indicated by X and Y, and are sorted into the group of unchangeable factor levels. Then these factor levels that have completed the experiment are inputted in the new blank experimental design table, at the same position as in the original experimental design table, as shown in Table 4.

TABLE 4

| | F1 | F2 | F3 | F4 | F5 |
|---|---|---|---|---|---|
| 1 | Y | Y | X | Y | |
| 2 | Y | Y | X | | |
| 3 | X | X | X | Y | |
| 4 | X | X | X | Y | |
| 5 | Y | Y | X | | |
| 6 | Y | Y | X | | |
| 7 | Y | Y | | | |
| 8 | Y | Y | | | |

The newly obtained factor levels comprising items that have not yet completed the experiment and the factor levels brought up by F5 are inputted in the new experimental design table in the positions other than the positions where the factor levels that have completed the experiments in a most preferable way, wherein the inputted factor levels are indicated by z, and the result is shown in Table 5. It should be noted the letter z is used for illustration purpose, and does not mean that the factor levels have the same meaning or have the same process parameters. It is also applicable to choose a random selection way to input the information, apart from the most preferable way.

TABLE 5

| | F1 | F2 | F3 | F4 | F5 |
|---|---|---|---|---|---|
| 1 | Y | Y | X | Y | z |
| 2 | Y | Y | X | z | z |
| 3 | X | X | X | Y | z |
| 4 | X | X | X | Y | z |
| 5 | Y | Y | X | z | z |
| 6 | Y | Y | X | z | z |
| 7 | Y | Y | z | z | z |
| 8 | Y | Y | z | z | z |

After the new factor levels are inputted in the new experimental design table, the experimental design process continues using this new experimental design table. The main purpose of step 17 is to examine whether the experimental target range is being changed during the experiment. If any modification is being made, then the method returns to step 12 to obtain new factors and factor levels, followed by steps 13-17, until the experimental design is completed without making any modification of the experimental target range. Until then, the experimental result and analysis report will be outputted as described in step 18.

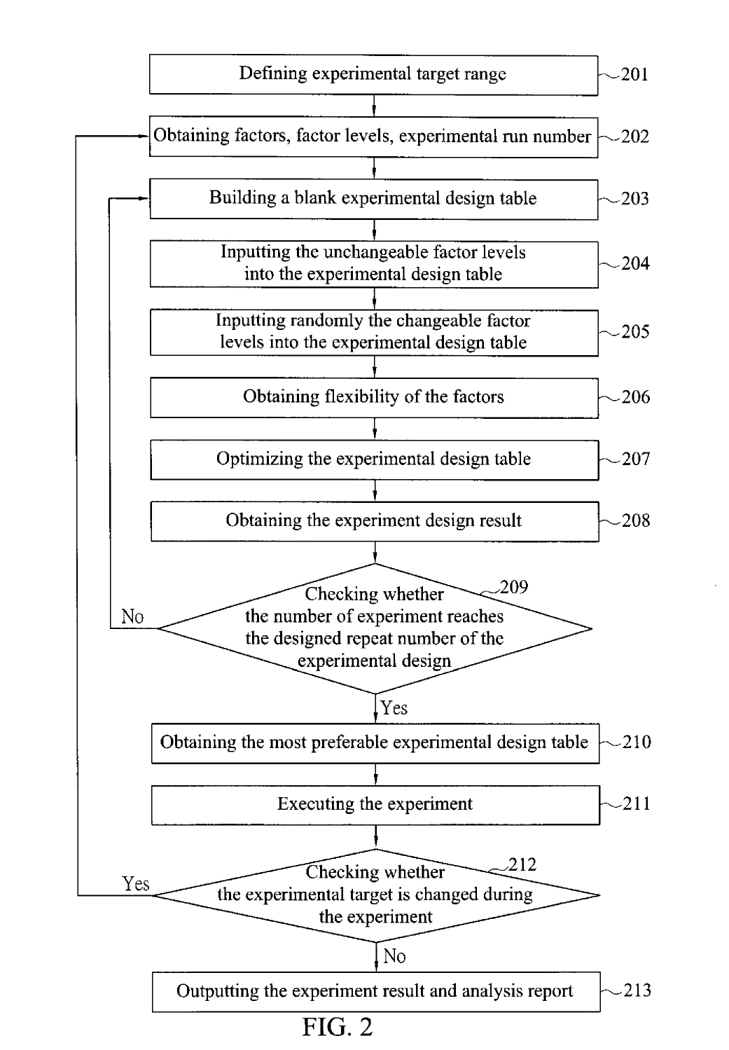

In another embodiment of the method for dynamic experimental design according to the present invention is shown in FIG. 2, wherein the contents described by steps 201-205 and 211-213 are the same as those of the steps 11-18. Hence, only the differences between the present embodiment and the aforesaid embodiment will be provided herein.

Step 201 relates to defining an experimental target range, and, more specifically, to defining the measuring standard of the experimental design and repeat number of the experimental design. The purpose of defining a repeat number of the experimental design is to enhance the quality of the experimental design table, which is primarily determined by the step of inputting the changeable items of the factor levels in the experimental design table. Since there are numerous ways to input the changeable factor levels in the experimental design table, leading to different experimental design table, not every input method leads to the most preferable experimental design table that is the most preferable way not necessary can be obtained using a formula. In light of this, a recursive search method is adopted to repetitively performing calculation to raise the possibility of finding the most preferable or closest to the most preferable solutions. Therefore the higher the repetitive number of the experimental design, the higher the quality of the experimental design, and the more time is required. Therefore an experimental target range must be predefined, with an appropriate repeat number and standard. The method proceeds to step 202.

Step 202 relates to confirming factors, factor levels and experimental runs. In step 203, a blank experimental design table is built, followed by inputting the unchangeable factor levels that cannot be changed due to experimental restrictions in the experimental design table, as describe in step 204. Subsequently, the changeable factor levels are inputted in the experimental design table in a random selection way (step 205). The random selection can be adopted here in conjunction with the aforesaid recursive search method which utilizes repetitive calculations to search for the most preferable or closest to the most preferable solution. Alternatively, other types of known preferable ways can be used to input the changeable factor levels, the methods of which are not limited by the present invention. The method proceeds to step 206.

Step 206 relates to obtaining the flexibility of the factors. The flexibility described herein refers to the dimensional flexibility for a set of data. For instance, when the sum of the total levels of one factor equals to 1, given each level of which is set to be L1, L2 and L3, i.e., L1+L2+L3=1, providing the levels of first and second experiment are confirmed, the level for the third experiment is also confirmed (i.e., when the levels of first and second experiment, namely L1 and L2 are set, the level of third experiment can be obtained using the formulae L3=1−L1−L2). Accordingly, the flexibility of the factors in the 3 experiments is 2 (because only two experiments can be adjusted). After the flexibility of factors is confirmed, the factor levels having the flexibility of each factor are adjusted gradually, i.e., optimizing the experimental design table in step 207. As the previous example, only the levels of the first experiment and second experiment have the flexibility, therefore only the levels of these two experiments are being adjusted, and the factor levels of the third experiment will be determined by the factor levels of the two experiments. In an embodiment, the level L2 of the second experiment is fixed in advance, and level L1 of the first experiment is optimized. When it is completed, the level L1 of the first experiment is fixed to optimize level L2 of the second experiment. This is repeated until the experimental design table cannot be optimized anymore by both Level L1 of the first experiment and level L2 of the second experiment. It should be noted, only single factor is illustrated in the adjustment method described above for illustration purpose and the preset invention is not limited to single factor adjustment.

After optimizing the experimental design table in step 207, a set experimental design result can be obtained (step 208) and stored in the data base. The method proceeds to step 209, to check whether the repeat number of the experimental design is reached. If the repeat number of the experimental design is not reached, the method returns to step 203 to build a blank experimental design table, followed by steps 203-208, such that a plurality of experimental design results can be obtained corresponding to the repeat number. When the number of experimental result accords with the repeat number, the most preferable result can be selected as the final experimental design table (step 210), to be executed (step 211). Subsequently, step 212 is performed to check whether the experimental target range is changed. Step 212 is the same as the aforementioned step 17, and detailed descriptions of step 212 will be thereby omitted. Step 213 is only performed if no more modification is made for the experimental target range. At this time, the experimental result and analysis result are outputted.

The method for dynamic experimental design according to the present invention is characterized by having high flexibility in response to change in experimental background, such as adding machines on the production line, changing process parameters in real time, such that the experimental factors can be dynamically adjusted accordingly therefore can be widely adopted in high-technology industries such as semiconductor industries, more over those factor levels that have completed experiments can be retained, thereby greatly reducing the time required for experimental design simulation, as a result, the prior art problem such as factors required to be set in response in time change can be overcome. The method for dynamic experimental design proposed by the present invention has the advantages of high flexibility and high stability.

The present invention has been described using exemplary preferred embodiments. However, it is to be understood that the scope of the present invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for dynamic experimental design, comprising:
defining an experimental target range, and obtaining at least one first factor, a plurality of first factor levels, and a plurality of experimental runs;
building a first experimental design table according to the at least one first factor and the experimental runs;
inputting the first factor levels to the first experimental design table;
executing an experiment according to the first experimental design table; and
checking whether the experimental target range is changed during the experiment;
wherein if the experimental target range is changed during the experiment, at least one second factor and at least one second factor level are obtained, the at least one second factor is added into a second experimental design table, some of the first factor levels that have completed the experiment and the second factor levels are inputted into the second experimental design table, an experimental design continues, and the experimental target range is kept checked, or an experimental result and an analysis report are outputted.

2. The method of claim 1, wherein the first factor levels comprise unchangeable ones due to experimental restrictions and changeable ones.

3. The method of claim 1, wherein the unchangeable ones due to experimental restrictions in the first factor levels are inputted in fixed positions of the first experimental design table according to the experimental restrictions.

4. The method of claim 3, wherein after the unchangeable ones of the first factor levels due to experimental restrictions are inputted, the changeable ones of the first factor levels are inputted in the first experimental design table at positions other than the fixed positions.

5. The method of claim 1, wherein the first factor levels that have completed the experiment are inputted in same positions of the second experimental design table as the position of the first experimental design table.

6. The method of claim 5, wherein the second factor levels are inputted in a second experimental design table in positions other than the positions of the first factor levels that have completed the experiment.

7. A method for dynamic experimental design, comprising:
defining an experimental target range, and obtaining at least one first factor, a plurality of first factor levels, and a plurality of experimental runs, wherein the experimental target range comprises a repeat number of experimental designs;
building at least one first experimental design table according to the repeat number of experimental designs, the at least one first factor, and the experimental runs;
inputting the first factor levels into the first experimental design table;
obtaining flexibility of the at least one first factor, and optimizing the first experimental design table, to obtain an experimental design result;
checking whether a number of the experimental design result reaches the repeat number of the experimental designs, and if the number of the experimental design result reaches the repeat number of the experimental designs, a most preferable one in the first experimental design table is outputted and the experiment continues, or the step of building the first experimental design table is executed again so as to obtain the experimental design result; and
checking whether the experimental target range is changed during the experiment;
wherein if the experimental target range is changed during the experiment, at least one second factor and at least one second factor level are obtained, the second factor is added into a second experimental design table, and some of the first factor levels that have completed the experiment and the second factor levels are input into the second experimental design table, the experimental design continues, and the experimental target range is kept checked, or an experimental result and an analysis report are outputted.

8. The method of claim 7, wherein the first factor levels comprise unchangeable ones due to experimental restrictions and changeable ones.

9. The method of claim 7, wherein the unchangeable ones of the first factor levels due to experimental restrictions are inputted in fixed positions of the first experimental design table according to the experimental restrictions, and after the ones of the first factor levels due the experimental restrictions, the changeable ones of the first factor levels are inputted in the first experimental design table at positions other than the fixed positions.

10. The method of claim 7, wherein the first factor levels that have completed the experiment are inputted in same positions of the second experimental design table as the positions of the first experimental design table, and the second factor levels are inputted in the second experimental design table at positions other than the positions of the first factor levels that have completed the experiment.
